(19) United States
(12) Patent Application Publication
(10) Pub. No.: US 2021/0304040 A1
(43) Pub. Date: Sep. 30, 2021

(54) FOD Mitigation System and Method

(71) Applicant: United States of America, as represented by the Secretary of the Navy, Patuxent River, MD (US)

(72) Inventors: Jonathan Sides, Leonardtown, MD (US); Guy Berry, East Aurora, NY (US)

(21) Appl. No.: 17/184,750

(22) Filed: Feb. 25, 2021

Related U.S. Application Data
(60) Provisional application No. 63/000,632, filed on Mar. 27, 2020.

(51) Int. Cl. G06N 5/04; H04L 29/08

(52) U.S. Cl. CPC G06N 5/045; H04L 67/12

(57) ABSTRACT

A FOD mitigation method which includes the steps of: identifying an airfield that has an engine FOD problem; identifying physical parameters on the airfield that have an impact on engine FOD; setting sensors in and around the airfield to accurately collect data, wherein the sensors are capable of accurately measuring physical parameters that define the airfield and able to detect a FOD event; routing data from the sensors to a central location, sanitizing the data and fusing the data using time as an independent variable; predicting FOD events using the data such that FOD event predictions are made; evaluating the predictions to determine their accuracy and confidence, utilizing the predictions to characterize the risk of a FOD event on the airfield; and informing an airfield operator of relative risks and predictions.

### CROSS-REFERENCES

The present application claims the benefit of Provisional Application No. 63/000,632 filed Mar. 27, 2020. The provisional application is incorporated herein by reference.

### STATEMENT OF GOVERNMENT INTEREST

The invention described herein may be manufactured and used by or for the Government of the United States of America for governmental purposes without payment of any royalties thereon or therefor.

### BACKGROUND

Airfield debris is a problem for aircraft particularly in the military. This debris is commonly referred to as FOD (foreign object damage). FOD is any article or substance, alien to an aircraft or system, which could potentially cause damage. Airfield debris or FOD is currently managed using vacuum trucks, friction mats, personnel walking at arms' length down airfields (FOD walks), and with other boutique debris collection tools. Each of these methods are slow, inefficient, and ultimately ineffective at managing damage caused by aircraft engines ingesting debris. Vacuum trucks are relatively small and slow, and when deployed, usually take a full week of operation to remediate an entire airfield. Friction mats can operate at higher speeds than vacuum trucks, but need to replaced frequently, and cause degradation of the airfield surfaces. FOD walks are time and labor intensive, and are only effective at finding large pieces of debris that easily stand out on the airfield. There have been attempts to utilize mobile radar trucks to find debris on the airfield, but false detections and insufficient thresh-holding have rendered them ineffective. Each of these methods are time intensive, and studies have shown that debris can return to airfield within hours of cleaning. Thus, even with all these tools fully operational, debris or FOD poses a risk to aircraft engines.

### SUMMARY

The present invention is directed to a FOD mitigation system and method with the needs enumerated above and below.

The present invention is directed to a FOD mitigation method includes the steps of: identifying an airfield that has an engine FOD problem; identifying physical parameters on the airfield that have an impact on engine FOD; setting sensors in and around the airfield to accurately collect data, the sensors are capable of accurately measuring physical parameters that define the airfield and able to detect a FOD event; routing data from the sensors to a central location, sanitizing the data and fusing the data using time as an independent variable; predicting FOD events using the data such that FOD event predictions are made; evaluating the predictions to determine their accuracy and confidence, utilizing the predictions to characterize the risk of a FOD event on the airfield; and informing an airfield operator of relative risks and predictions.

It is a feature of the present invention to provide a FOD mitigation system and method that saves time, money and significant work hours.

It is a feature of the present invention to a FOD mitigation system and method that gives an airfield operator risk factors of a potential FOD event.

### DRAWINGS

These and other features, aspects and advantages of the present invention will become better understood with reference to the following description and appended claims, and accompanying drawings wherein:

FIG. 1 is a flow diagram describing the method for FOD mitigation; and

FIGS. 2A and 2B are a depiction of the FOD mitigation system.

### DESCRIPTION

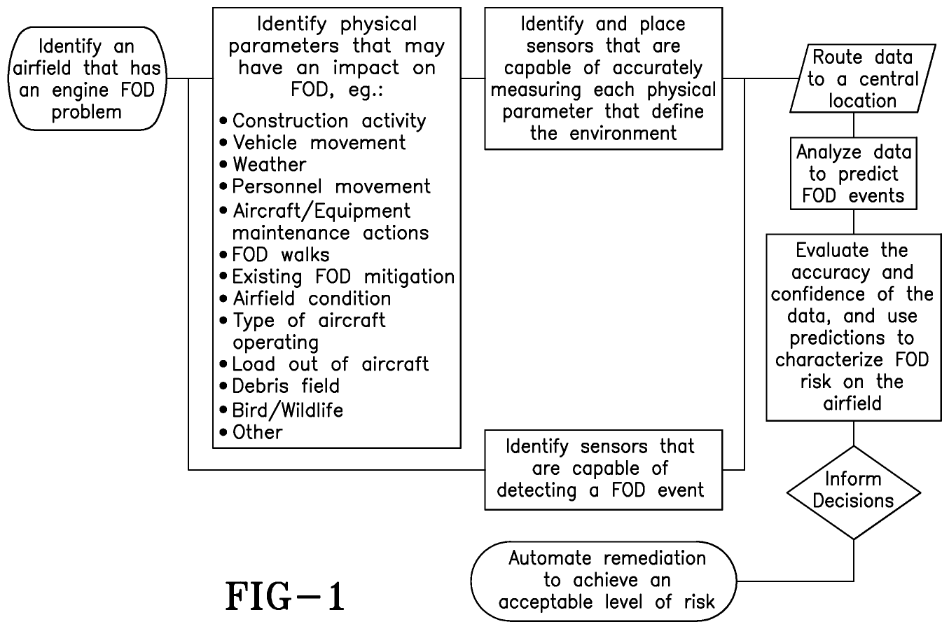

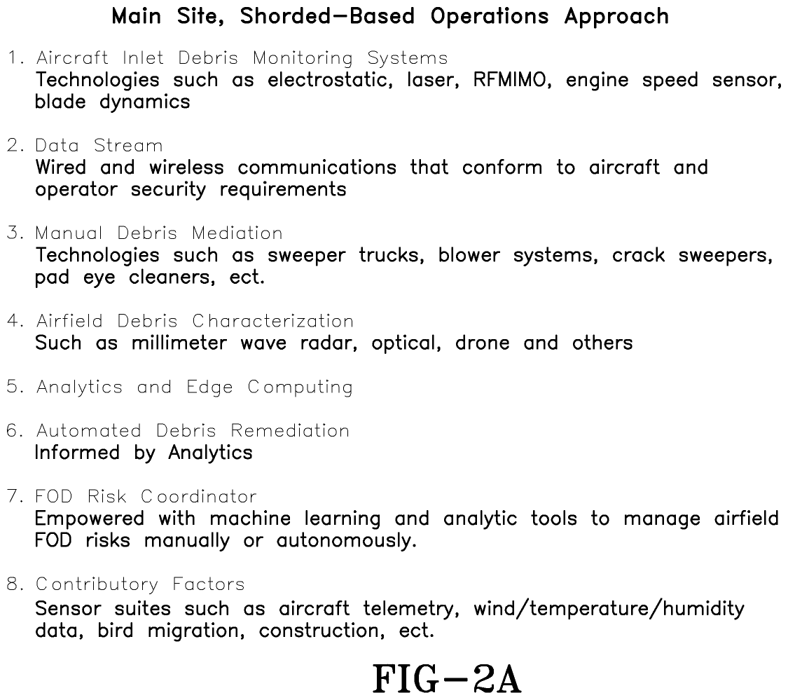

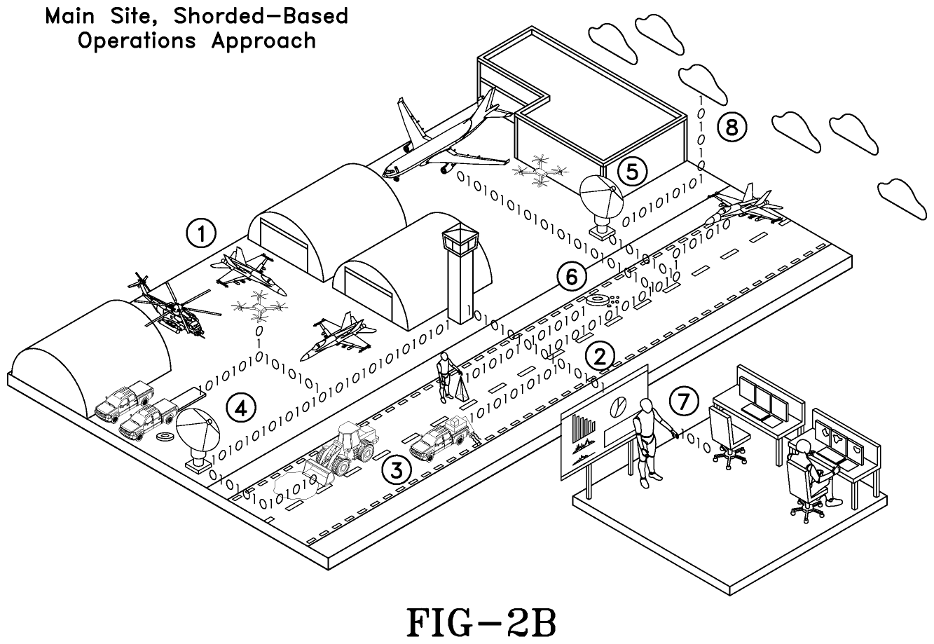

The preferred embodiments of the present invention are illustrated by way of example below and in FIGS. 1-2. As seen in FIG. 1, the FOD mitigation method includes the steps of: identifying an airfield that has an engine FOD problem; identifying physical parameters on the airfield that have an impact on engine FOD; setting sensors in and around the airfield to accurately collect data, wherein the sensors are capable of accurately measuring physical parameters that define the airfield and able to detect a FOD event; routing data from the sensors to a central location, sanitizing the data and fusing the data using time as an independent variable; predicting FOD events using the data such that FOD event predictions are made; evaluating the predictions to determine their accuracy and confidence, utilizing the predictions to characterize the risk of a FOD event on the airfield; informing an airfield operator of relative risks and predictions; and mitigating residual risk through physical and automated means (FIG. 2B, items 3 and 6).

In the description of the present invention, the invention will be discussed in a military environment; however, this invention can be utilized for any type of application that requires use of airfield.

The physical parameters that contribute to a FOD event, and the corresponding sensors that characterize them can be seen in FIGS. 2A and 2B. These parameters include (shown in FIG. 2B, item 8), but are not limited to, construction activity, vehicle movement, weather, personnel movement, aircraft/equipment maintenance actions, FOD Walks, existing FOD mitigation, with examples shown in FIG. 2B, item 3, airfield condition (to include aprons, runways, taxiways, tarmac, etc . . . ), type of aircraft operating, load out of operating aircraft, debris field, bird/wildlife activity, and any other factors that may have an impact on engine FOD.

The sensors that are capable of detecting a FOD event may detect debris that enters an engine inlet, debris that hits and/or damages the engine, and debris that hits the engine. These are embodied in FIG. 2B, item 1. The sensors may measure blade passing frequency to look for minor changes in rotor blade time of arrival indicating potential impact or damage. Other technologies may utilize radio frequencies with multiple input/multiple output to look for debris entering an inlet. This same technology can also be used to detect blade passing frequency as well as geometric changes, such as damage, to the rotor blades. Additional technologies may include measuring the charge of incoming particles utilizing an electrostatic sensor. Another approach may be to measure minor variations in shaft speed as a result of debris impacting rotor blades. Another approach may be to measure reflected light from a laser source.

In one of the embodiments of the invention, the data, FIG. 2B, item 2, is routed to a central location via edge computing, FIG. 2B, item 7. Edge computing, seen in FIG. 2B, item 5, may be defined, but without limitation, as a distributed computing paradigm which brings computation and data storage closer to the location where it is needed, to improve response times and save bandwidth. In particular, the invention, may utilize millimeter wave radar data (FIG. 2B, item 4). Millimeter wave radar data may be defined, but without limitation, as a short range millimeter wave imaging radar system. The invention may utilize electronics adapted to produce millimeter wave radiation scanned over a frequency range of a few gigahertz. The scanned millimeter wave radiation is broadcast through a frequency scanned transmit antenna to produce a narrow transmit beam in a first scanned direction (such as the vertical direction) corresponding to the scanned millimeter wave frequencies. The transmit antenna is scanned to transmit a beam in a second direction perpendicular to the first scanned direction (such as the horizontal or the azimuthal direction) so as to define a two-dimensional field of view. Reflected millimeter wave radiation is collected in a receive frequency scanned antenna co-located (or approximately co-located) with the transmit antenna and adapted to produce a narrow receive beam approximately co-directed in the same directions as the transmitted beam in approximately the same field of view. Computer processor equipment compares the intensity of the receive millimeter radar signals for a pre-determined set of ranges and known directions of the transmission and receive beams as a function of time to produce a radar image of at least a. desired portion of the field of view. Alternatively, another embodiment of the invention is a system for detection of foreign objects on an aircraft travel surface and ascription of the foreign objects present on the aircraft travel surface to foreign object sources. The system includes a foreign object detection subsystem operative to detect foreign objects on an aircraft travel surface, a potential foreign object source identifier subsystem operative to indicate the presence of potential foreign object sources at or near the aircraft travel surface, and a foreign object to foreign object source correlator. The source correlator receives inputs from the foreign object detection subsystem and from the foreign object source identifier subsystem. This indicates at least a time relationship between sensed presence of the potential foreign object sources on the aircraft travel surface and detection of the foreign objects. The invention also provides an ascription output indicating the origin of at least some of the foreign objects detected by the foreign object detection subsystem.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A FOD mitigation method comprising the steps of:
identifying an airfield that has an engine FOD problem;
identifying physical parameters on the airfield that have an impact on engine FOD;
setting sensors in and around the airfield to accurately collect data, the sensors are capable of accurately measuring physical parameters that define the airfield and able to detect a FOD event;
routing data from the sensors to a central location;
sanitizing the data and fusing the data using time as an independent variable;
predicting FOD events using the data and analytics such that FOD event predictions are made;
evaluating the predictions to determine their accuracy and confidence;
utilizing the predictions to characterize the risk of a FOD event on the airfield; and,
informing an airfield operator of relative risks and predictions.

2. The method of claim 1, wherein the method further includes automating decisions on whether to utilize the airfield and fly aircraft from the airfield.

3. A FOD mitigation System comprising of:
an identifier that identifies physical parameters of an airfield;
sensors that measure each of the physical parameters and collect data;
a router that sends the data to a central location;
a sanitizer that sanitizes the data and fuses it using time as an independent variable;
a predictor that predicts FOD events from the sanitized and fused data; and,
an informer that informs an airfield operator the predicted events from the predictor.
